(19) United States
(12) Patent Application Publication
(10) Pub. No.: US 2026/0195519 A1
(43) Pub. Date: Jul. 9, 2026

(54) Circuit design method and electronic device executing the circuit design method

(71) Applicant: REALTEK SEMICONDUCTOR CORPORATION, HSINCHU (TW)

(72) Inventors: YEN-LIN PENG, HSINCHU (TW); HUAI-EN YI, HSINCHU (TW)

(21) Appl. No.: 19/438,830

(22) Filed: Jan. 2, 2026

(30) Foreign Application Priority Data
Jan. 6, 2025 (TW) 114100457

(51) Int. Cl. G06F 30/398

(52) U.S. Cl. CPC G06F 30/398

(57) ABSTRACT

A circuit design method executed by an electronic device includes the following steps: performing an IR drop analysis based on circuit placement data; selecting a target cell; replacing the target cell with a sub-cell; setting up a buffer cell; placing the buffer cell in an area; and connecting the sub-cell and the buffer cell with a routing.

### BACKGROUND OF THE INVENTION

### 1. Field of the Invention

The present invention generally relates to a circuit design method, and more particularly, to the processing of a voltage drop (hereinafter referred to as “IR drop”) at the back end of the circuit design.

### 2. Description of Related Art

IR drop is a phenomenon in electronic circuits. FIG. 1 shows an IR drop analysis diagram. The figure contains multiple low IR drop cells C1, multiple medium IR drop cells C2, and multiple high IR drop cells C3. The IR drop of the low IR drop cell C1 is less than that of the medium IR drop cell C2, and the IR drop of the medium IR drop cell C2 is less than that of the high IR drop cell C3. The area 101 and the area 102 are blank areas (i.e., there are no cells in the area), and the area 101 and the area 102 are substantially surrounded by the low IR drop cells C1. In other words, the area 101 and the area 102 are located within a range where the IR drop is relatively low.

The cells 111, 112, 113, and 114 are located within a range where the IR drop is relatively high. In other words, the area where the cells 111 to 114 are located is an area where the IR drop is relatively high. (i.e., an IR drop hot spot).

Excessive IR drop can cause the performance of electronic circuits to decrease, or even malfunction. Therefore, it is urgent that this issue is resolved.

### SUMMARY OF THE INVENTION

In view of the issues of the prior art, an object of the present invention is to provide a circuit design method and an electronic device executing the circuit design method, so as to make an improvement to the prior art.

According to one aspect of the present invention, electronic device is provided. The electronic device includes a memory and a computing circuit. The memory is configured to store a circuit placement data and a plurality of codes and/or program instructions. The computing circuit is coupled to the memory and is configured to execute the plurality of codes and/or program instructions to perform the following steps: performing an IR drop analysis based on the circuit placement data; selecting a target cell; replacing the target cell with a sub-cell; setting up a buffer cell; placing the buffer cell in an area; and connecting the sub-cell and the buffer cell with a routing.

According to another aspect of the present invention, an electronic device is provided. The electronic device includes a memory and a computing circuit. The memory is configured to store a circuit placement data and a plurality of codes and/or program instructions. The computing circuit is coupled to the memory and is configured to execute the plurality of codes and/or program instructions to perform the following steps: solving a timing issue of circuit placement based on the circuit placement data; performing an IR drop analysis based on the circuit placement data; and replacing a target cell with a sub-cell and setting up a buffer cell when an IR drop of the target cell is greater than or equal to a threshold, and a size of the target cell is greater than or equal to a size threshold.

According to still another aspect of the present invention, a circuit design method is provided. The circuit design method includes the following steps: performing an IR drop analysis based on a circuit placement data; selecting a target cell; replacing the target cell with a sub-cell; setting up a buffer cell; placing the buffer cell in an area; and connecting the sub-cell and the buffer cell with a routing.

The technical means embodied in the embodiments of the present invention can solve at least one of the problems of the prior art. Therefore, compared to the prior art, the present invention can resolve the IR drop issue.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows an IR drop analysis diagram.

FIG. 2 is the functional block diagram of an electronic device according to an embodiment of the present invention.

FIG. 3 is the flowchart of a circuit design method according to an embodiment of the present invention.

FIGS. 4A and 4B are the schematic diagrams illustrating the division of a cell according to an embodiment of the present invention.

FIG. 5 is the IR drop analysis diagram according to an embodiment of the present invention.

FIG. 6 is the flowchart of a circuit design method according to another embodiment of the present invention.

FIG. 7 is the schematic diagram illustrating the division of a cell according to another embodiment of the present invention.

FIG. 8 is the flowchart of a circuit design method according to another embodiment of the present invention.

FIG. 9 is the IR drop analysis diagram according to another embodiment of the present invention.

FIG. 10 is the schematic diagram illustrating the selection of a target cell to be divided according to an embodiment of the present invention.

FIG. 11 is a schematic diagram illustrating the selection of a target cell to be divided according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a circuit design method and an electronic device executing the circuit design method. On account of that some or all elements of the electronic device could be known, the detail of such elements is omitted provided that such detail has little to do with the features of this disclosure, and that this omission nowhere dissatisfies the specification and enablement requirements. Some or all of the processes of the circuit design method may be implemented by software and/or firmware and can be performed by the electronic device or its equivalent. A person having ordinary skill in the art can choose components or steps equivalent to those described in this specification to carry out the present invention, which means that the scope of this invention is not limited to the embodiments in the specification.

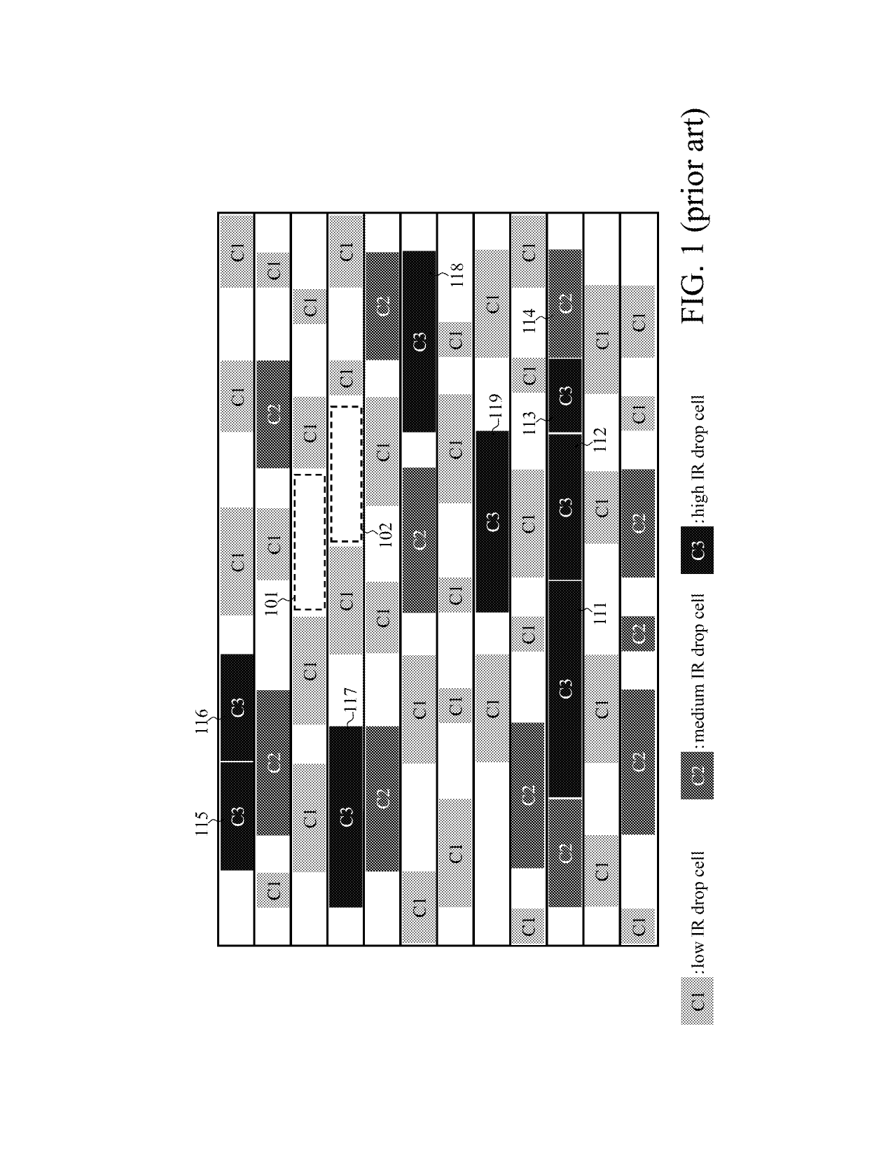

The following discussion will use the area where the cells 111 to 114 in FIG. 1 are located as an example to explain how this invention resolves the issue of high IR drop.

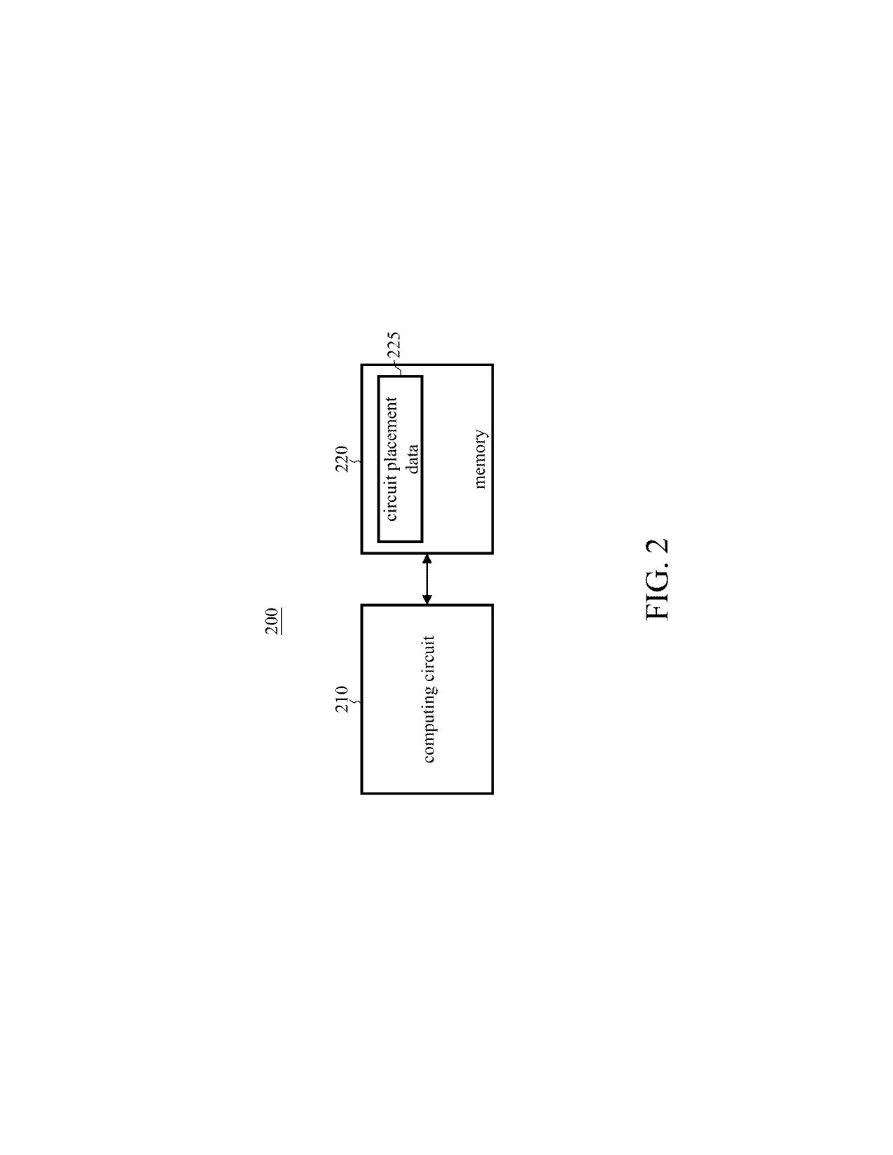

Reference is made to FIG. 2, which is a functional block diagram of an electronic device according to an embodiment of the present invention. The electronic device 200 includes the computing circuit 210 and the memory 220. The electronic device 200 may be a general-purpose computer, or a special-purpose computer used specifically for electronic circuit design. In some embodiments, the computing circuit 210 may be a circuit or electronic component with program execution capability, such as a central processing unit, a microprocessor, a microcontroller, an application-specific integrated circuit (ASIC), or an equivalent circuit. The computing circuit 210 implements all or some of the functions of the electronic device 200 (which include, but are not limited to, the functions discussed below) by executing codes and/or program instructions stored in the memory 220.

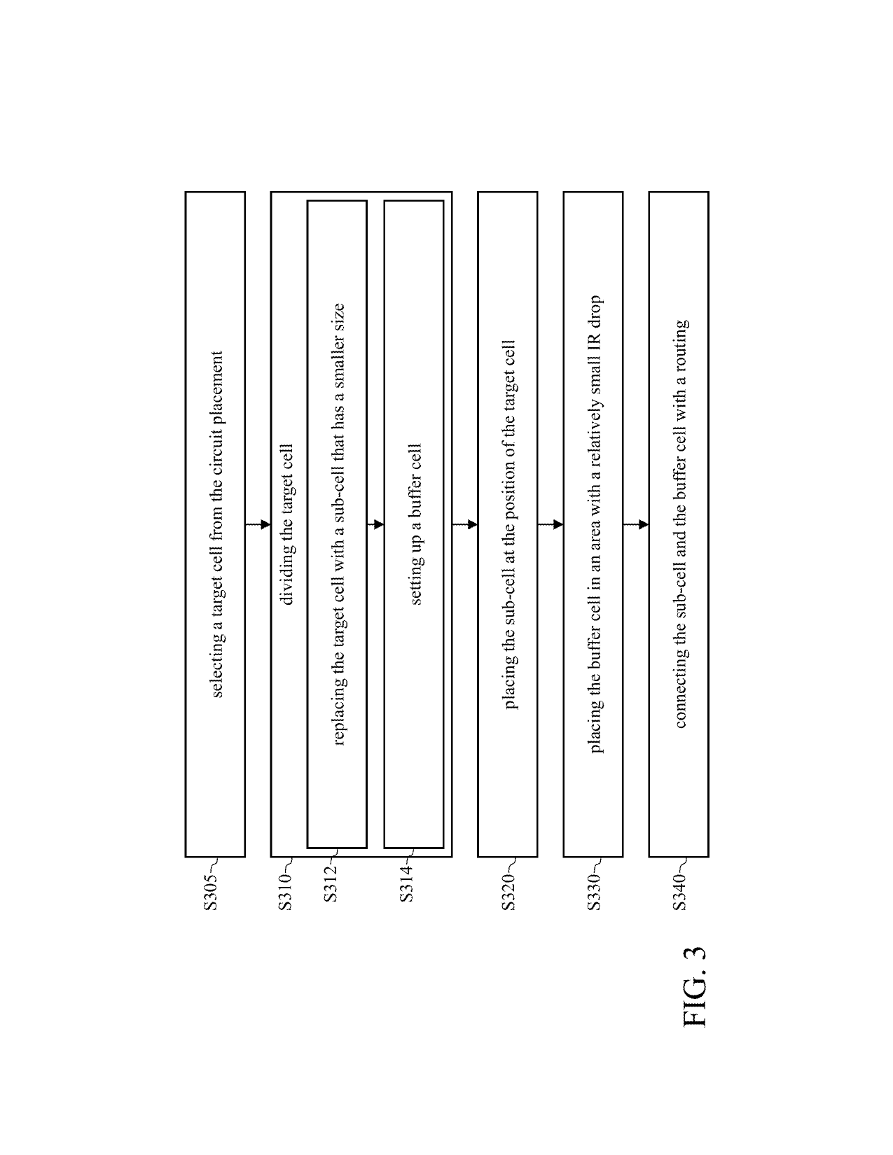

Reference is made to FIG. 3, which is the flowchart of a circuit design method according to an embodiment of the present invention. The circuit design method is used for back-end processing in circuit design, which includes the following steps.

Step S305: The computing circuit 210 selects a target cell from the circuit placement (e.g., one of the multiple cells shown in FIG. 1). The circuit placement data 225 can be stored in the memory 220.

Step S310: The computing circuit 210 divides the target cell. Step S310 includes the sub-step S312 and the sub-step S314.

Step S312: The computing circuit 210 replaces the target cell with a sub-cell. The sub-cell has substantially the same function or logic as the target cell, but the size of the sub-cell is smaller than the size of the target cell. In some embodiments, it is possible to reduce the size of the cell by decreasing the channel aspect ratio of the component(s) within the cell.

Step S314: The computing circuit 210 sets up a buffer cell. The following discussion uses the cell 111 in FIG. 1 as the target cell.

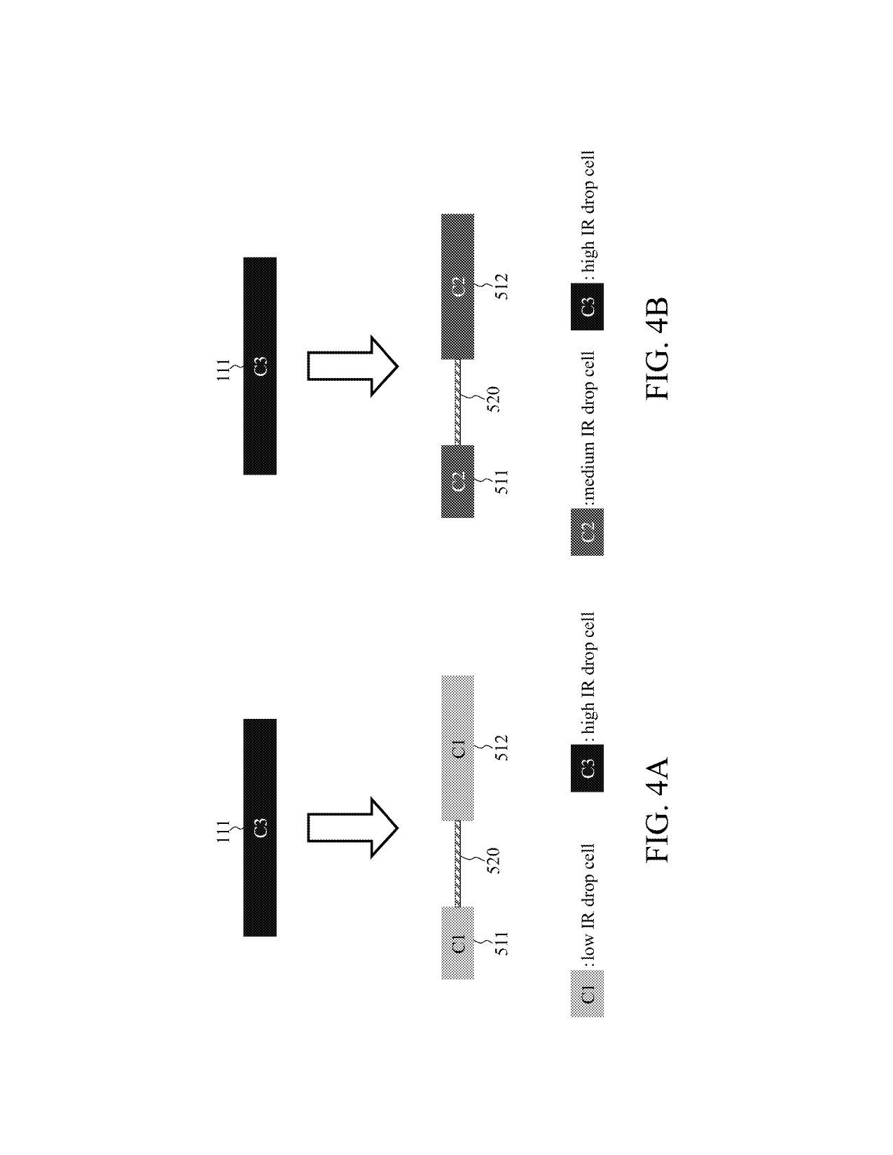

Reference is made to FIG. 4A and FIG. 4B, which are the schematic diagrams illustrating the division of a cell according to an embodiment of the present invention. The target cell 111 is divided into the sub-cell 511 and the buffer cell 512. The sub-cell 511 is connected to the buffer cell 512 through a routing 520. In some applications, the routing may also be referred to as a net. In FIG. 4A, the target cell 111 is divided into two low IR drop cells C1. In FIG. 4B, the target cell 111 is divided into two medium IR drop cells C2.

The computing circuit 210 divides the cell 111 according to the following rules: (1) The size (S0) of the cell 111 is greater than the sum of the size (S1) of the sub-cell 511 and the size (S2) of the buffer cell 512 (i.e., S0 > S1 + S2); and/or (2) the power consumption (W0) of the cell 111 is greater than the sum of the power consumption (W1) of the sub-cell 511 and the power consumption (W2) of the buffer cell 512 (i.e., W0 > W1 + W2).

In some embodiments, the computing circuit 210 selects a target cell with a size greater than or equal to N units in step S305 (where N is a positive integer greater than or equal to a preset value), and the sizes of the sub-cell 511 and the buffer cell 512 after division are two units and N-4 units, respectively. The preset value can be greater than or equal to six units.

In some embodiments, the cell 111 and the sub-cell 511 are logic cells (e.g., a combinational logic cell), but not a buffer cell.

Continuing with FIG. 3.

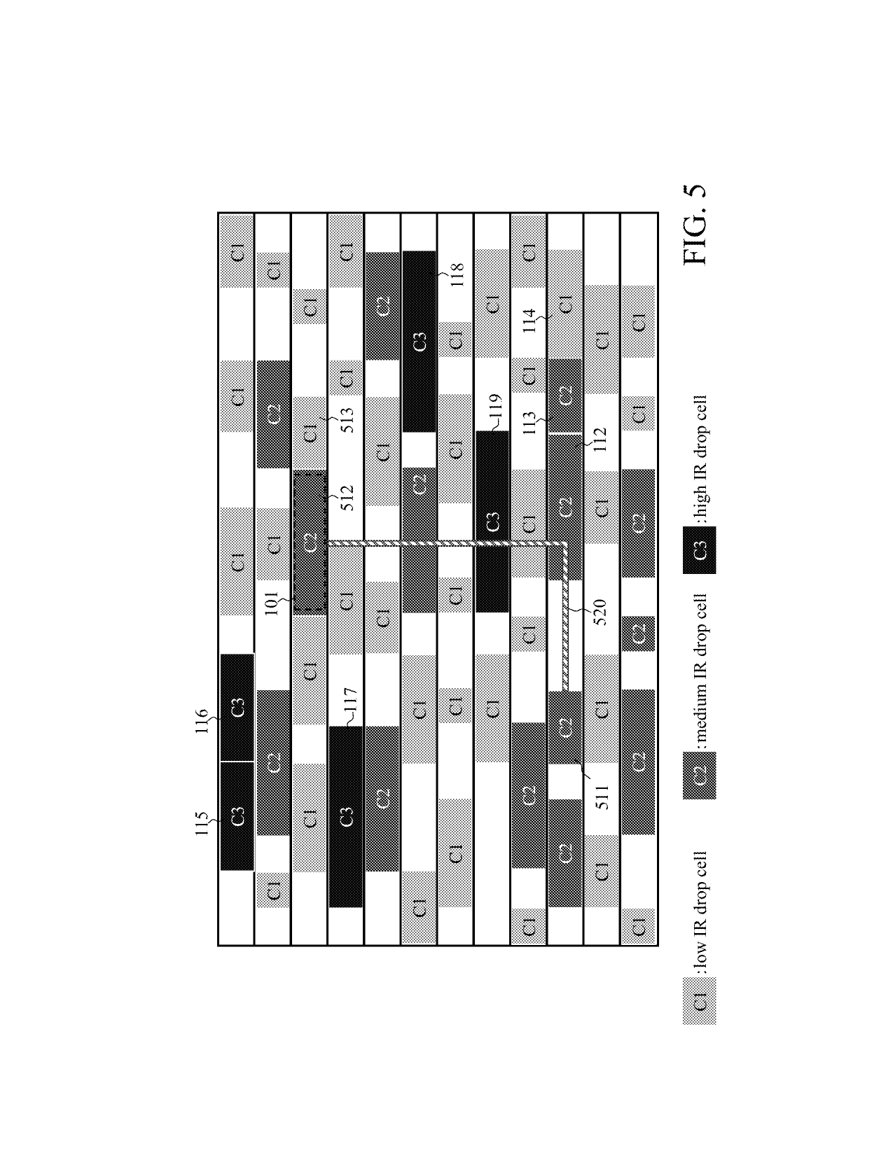

Step S320: The computing circuit 210 places the sub-cell 511 at the position of the target cell 111. Reference is made to both FIG. 1 and FIG. 5. FIG. 5 is an embodiment of the IR drop analysis diagram according to the present invention. The sub-cell 511 is placed at the original position of the cell 111. More specifically, in some embodiments, the range of the sub-cell 511 partially or completely overlaps with the range of the cell 111.

Step S330: The computing circuit 210 places the buffer cell 512 in an area with a relatively small IR drop (e.g., the area 101 or the area 102 in FIG. 1). Referring to FIG. 5, the buffer cell 512 is placed in the area 101, and the sub-cell 511 and the buffer cell 512 are connected through the routing 520. As shown in FIG. 1, the IR drop of the cells adjacent to the area 101 and the area 102 (i.e., the low IR drop cells C1, such as the cell 513) is less than the IR drop of the cell 111 (i.e., the high IR drop cell C3) itself. The buffer cell 512 is used to drive the cell that is originally connected to the cell 111 (i.e., the cell 513).

Step S340: The computing circuit 210 connects the sub-cell 511 and the buffer cell 512 with the routing 520.

As shown in FIG. 4A, FIG. 4B, and FIG. 5 (corresponding to FIG. 4B), after the cell 111 is divided, two cells with lower IR drops are formed (i.e., the sub-cell 511 and the buffer cell 512). This not only reduces the IR drop of the original cell (i.e., the cell 111) itself, but also further lowers the IR drops of the neighboring cells 112, 113, and 114. In other words, the area where the sub-cell 511, the cell 112, and the cell 113 are located is no longer an IR drop hot spot, thereby reducing the overall IR drop of the circuit placement.

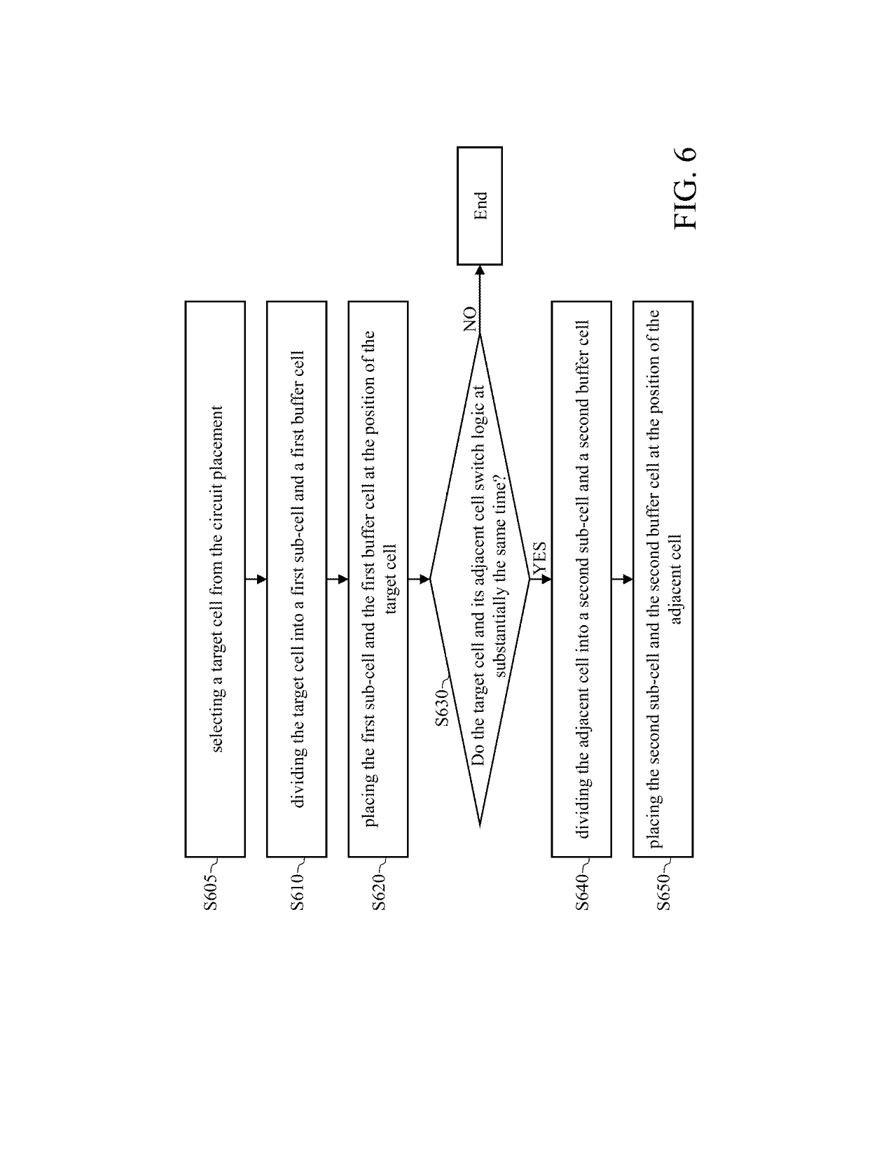

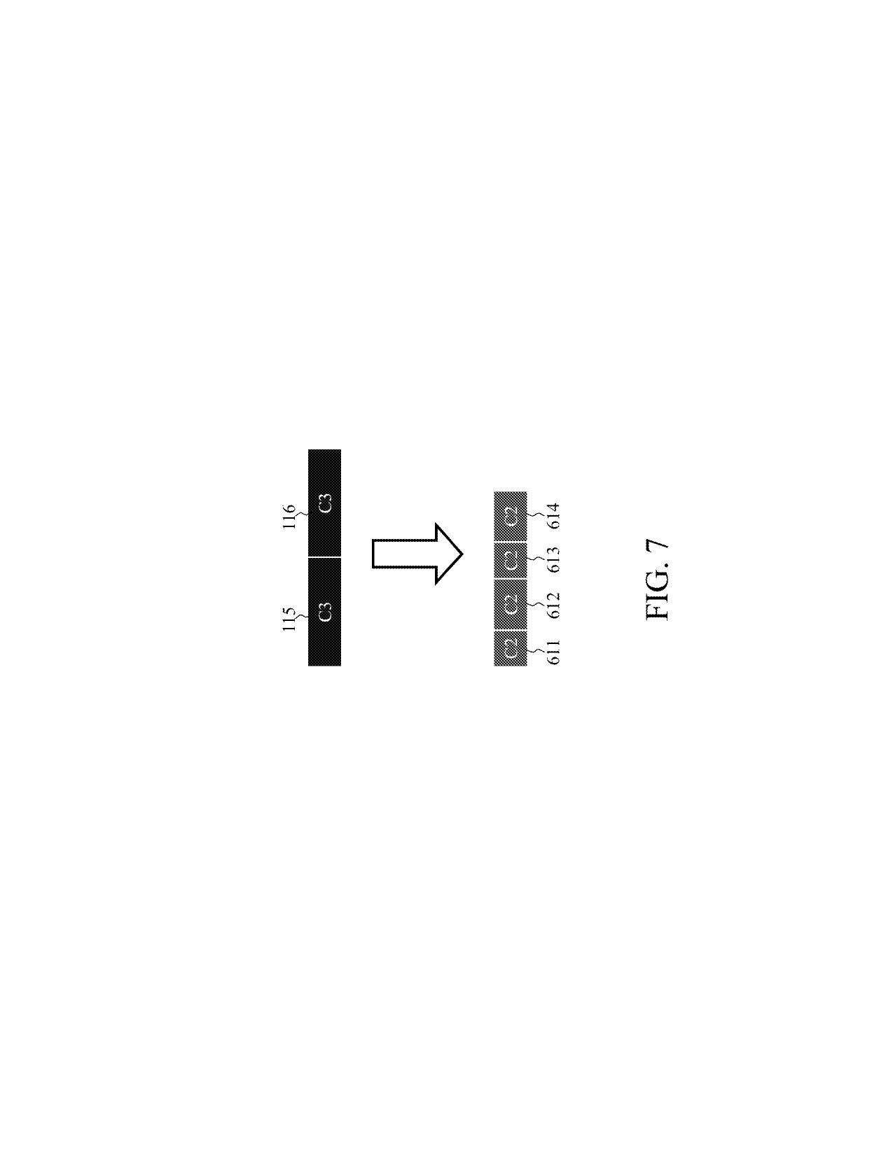

Reference is made to FIG. 6, which is a flowchart of the circuit design method according to another embodiment of the present invention. The circuit design method is used for back-end processing in the circuit design, which includes the following steps. Please also refer to FIG. 7, which is the schematic diagram corresponding to FIG. 6. Similar to FIGS. 4A and 4B, the cells 115 and 116 in FIG. 7 can each be divided into two low IR drop cells C1 or two medium IR drop cells C2. FIG. 7 is illustrated using the medium IR drop cell C2 as an example.

Step S605: The computing circuit 210 selects a target cell from the circuit placement. In this example, the target cell is the cell 115 in FIG. 1. The circuit placement data 225 can be stored in the memory 220.

Step S610: The computing circuit 210 divides the target cell into a first sub-cell 611 and a first buffer cell 612. Step S610 is similar to step S310; refer to the discussion of step S310.

Step S620: The computing circuit 210 places the first sub-cell and the first buffer cell at the position of the target cell. In some embodiments, the range of the sub-cell 611 partially or completely overlaps with the range of the cell 115, and the range of the buffer cell 612 partially or completely overlaps with the range of the cell 115.

Step S630: The computing circuit 210 determines whether the target cell and its adjacent cell switch logic at substantially the same time. In the example of FIG. 1 and FIG. 5, the cell 115 and the cell 116 are adjacent cells. The fact that two cells switch logic at substantially the same time means that the output levels of the two cells switch at substantially the same time; that is to say, the IR drops of the two cells occur at substantially the same time, and the two cells consume power at substantially the same time.

Step S640: The computing circuit 210 divides the adjacent cell 116 into a second sub-cell and a second buffer cell. As shown in FIG. 7, the cell 116 is divided into the second sub-cell 613 and the second buffer cell 614. Step S640 is similar to step S610.

Step S650: The computing circuit 210 places the second sub-cell 613 and the second buffer cell 614 at the position of the adjacent cell 116. Step S650 is similar to step S620; refer to the discussion of step S620.

Similarly, the size of the cell 115 (S3) is greater than the sum of the size of the sub-cell 611 (S4) and the size of the buffer cell 612 (S5) (i.e., S3 > S4 + S5); and/or the power consumption W3 of the cell 115 is greater than the sum of the power consumption W4 of the sub-cell 611 and the power consumption W5 of the buffer cell 612 (i.e., W3 > W4 + W5).

Similarly, the size of the cell 116 (S6) is greater than the sum of the size of the sub-cell 613 (S7) and the size of the buffer cell 614 (S8) (i.e., S6 > S7 + S8); and/or the power consumption (W6) of the cell 116 is greater than the sum of the power consumption (W7) of the sub-cell 613 and the power consumption (W8) of the buffer cell 614 (i.e., W6 > W7 + W8).

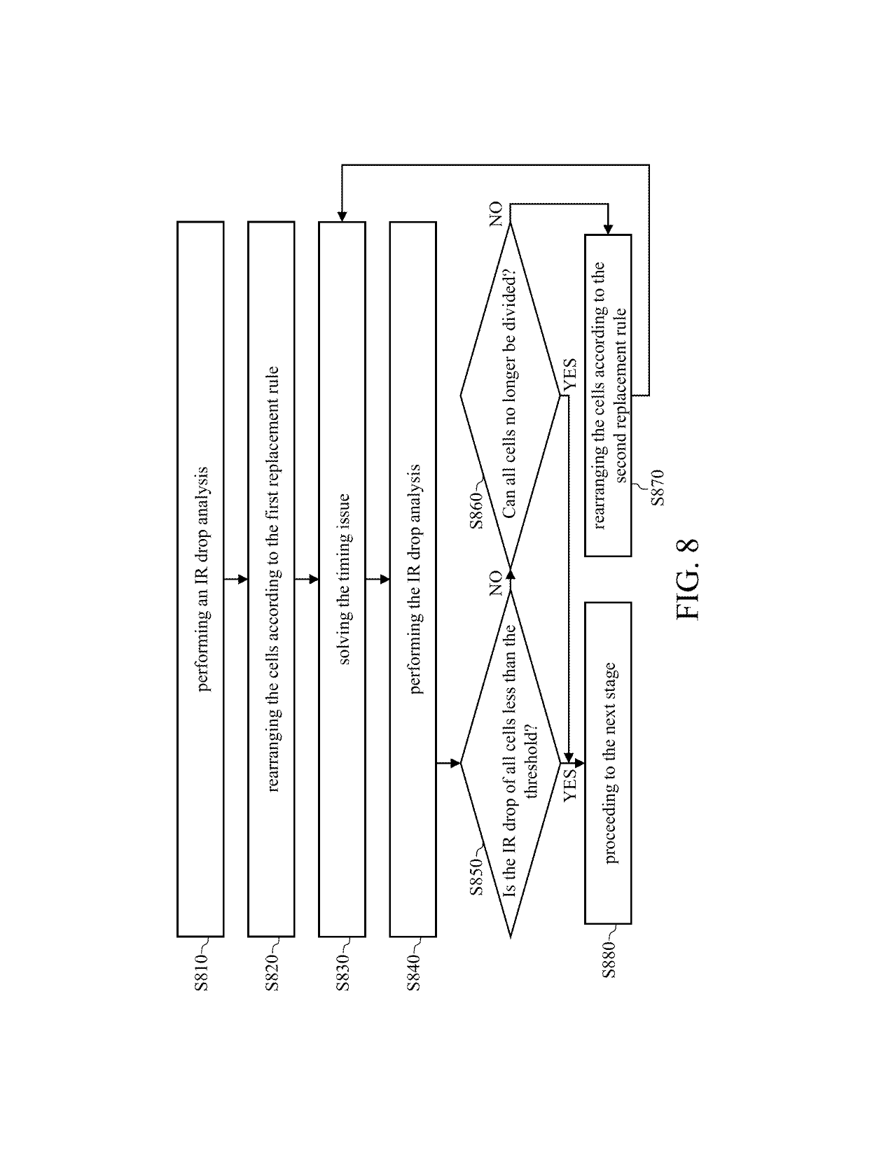

Reference is made to FIG. 8, which is a flowchart of the circuit design method according to another embodiment of the present invention. The circuit design method is used for back-end processing in the circuit design, which includes the following steps.

Step S810: The computing circuit 210 performs an IR drop analysis on the circuit placement (e.g., FIG. 1) that has preliminarily completed automatic placement and routing (APR). For example, the result of the analysis can be as shown in FIG. 1.

Step S820: The computing circuit 210 rearranges the cells according to the first replacement rule. For example, the first replacement rule can be the flowchart shown in FIG. 3, and the distribution of the cells after replacement can be as shown in FIG. 5. It should be noted that FIG. 5 illustrates the example of replacing only one cell; in actual operation, more cells can be replaced.

Step S830: The computing circuit 210 solves the timing issue of circuit placement based on the circuit placement data 225. The details of this step are well known to people having ordinary skill in the art, so further elaboration is omitted for brevity. It should be noted that step S830 is not the focus of this invention, and in order to concentrate on the discussion of the IR drop analysis of this disclosure, it is assumed here that step S830 does not rearrange the cells in FIG. 5.

Step S840: The computing circuit 210 performs the IR drop analysis on the circuit placement after solving the timing issue (e.g., FIG. 5). It should be noted that, in most cases, the computing circuit 210 does not move the existing cells after solving the timing issue to avoid generating new timing issues.

Step S850: The computing circuit 210 determines whether the IR drop of all cells is less than the threshold. For example, if the threshold corresponds to the IR drop of the high IR drop cells C3, then in FIG. 5, the IR drops of at least the cells 115, 116, 117, 118, and 119 are not less than the threshold. When the result of step S850 is YES, the flow proceeds to step S880; otherwise, the flow proceeds to step S860.

Step S860: The computing circuit 210 determines whether all cells can no longer be divided. For example, when the size of a cell is smaller than a certain size threshold, the cell can no longer be divided. When the result of step S860 is YES, the flow proceeds to step S880; otherwise, the flow proceeds to step S870.

In the example of FIG. 5, if the size of the cell 115 and the size of the cell 116 are greater than or equal to the size threshold, then the results of both step S850 and step S860 are negative.

Step S870: The computing circuit 210 rearranges the cells according to the second replacement rule. For example, the second replacement rule can be the process shown in FIG. 6. After step S870 ends, the computing circuit 210 again solves the timing issue (step S830).

Step S880: The computing circuit 210 finishes the IR drop analysis and controls the back-end processing of the circuit design to proceed to the next stage.

It should be noted that because step S870 only divides the target cell but does not move the cell (i.e., the sub-cell and the buffer cell resulting from the division are substantially located at the position of the original target cell), the impact on the overall timing is minimal.

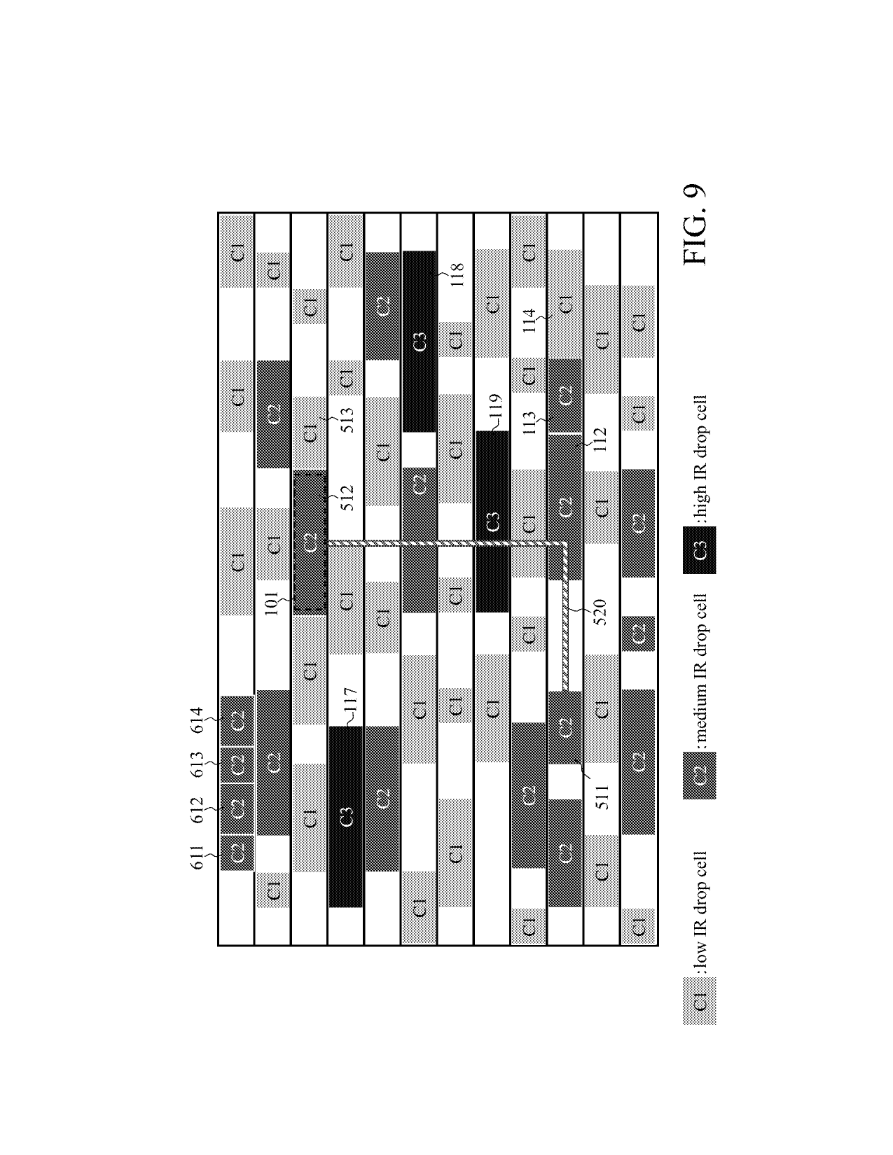

Reference is made to FIG. 9, which is another embodiment of the IR drop analysis diagram according to the present invention. After performing the IR drop analysis on FIG. 5 (step S840), the computing circuit 210 finds that the IR drops of the cells 115 to 119 are still greater than or equal to the threshold (step S850 is NO) and that at least the cell 115 and the cell 116 can be further divided (step S860 is NO). Therefore, the computing circuit 210 divides the cell 115 and the cell 116 according to the flowchart in FIG. 6 (step S870, see FIG. 7), resulting in the cell distribution shown in FIG. 9. Next, the computing circuit 210 continues to perform steps S830 to S870 until the IR drop of all cells is less than the threshold (step S850 is YES) or all cells can no longer be divided (step S860 is YES).

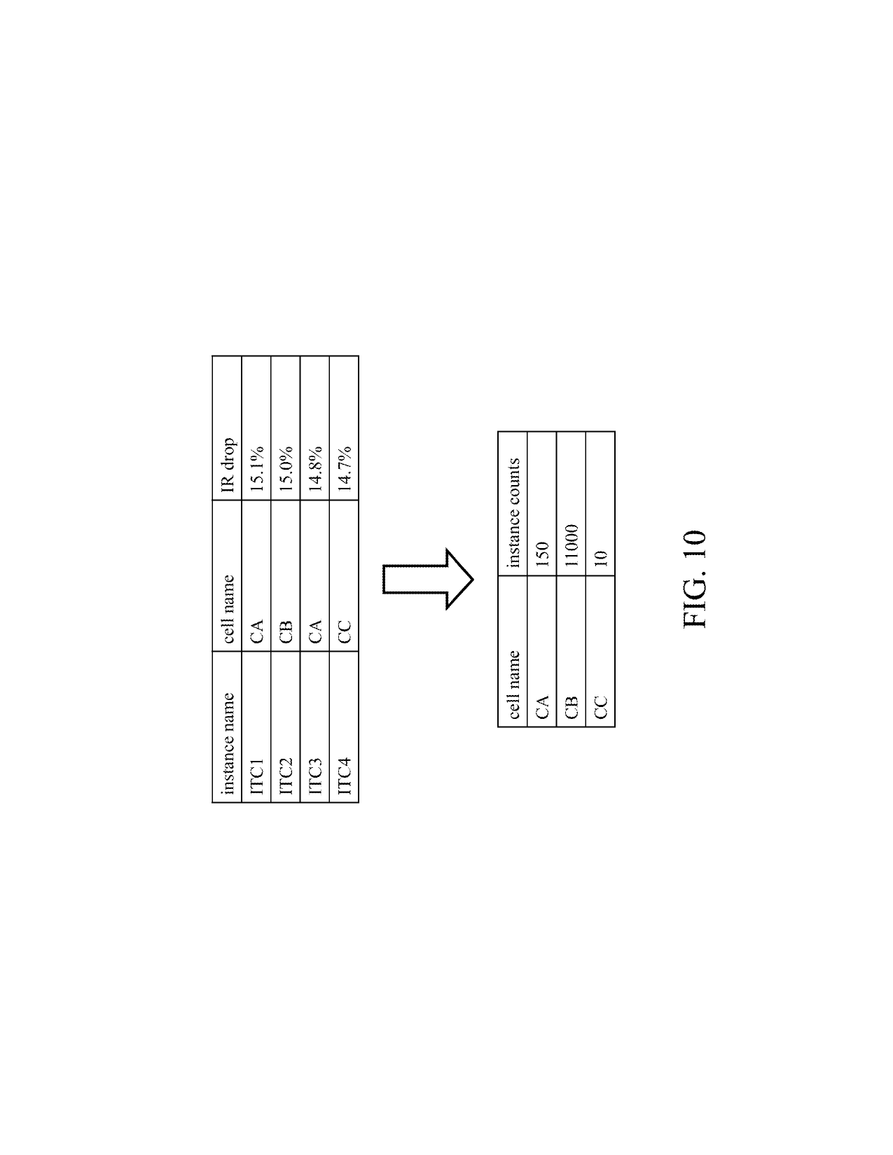

Reference is made to FIG. 10, which is a schematic diagram illustrating the selection of a target cell to be divided at an early stage of circuit placement according to an embodiment of the present invention. In the early stage of circuit placement, the cells are likely to change. In other words, the cells with large IR drops at this stage may not be the cells with large IR drops in the later stage. However, it is still very useful to divide the cells that may have large IR drops in advance. After performing step S810 of FIG. 8, the computing circuit 210 performs statistical analysis on the IR drop analysis diagram (e.g., FIG. 1) to generate the table shown in FIG. 10. In the example of FIG. 10, the instance ITC1 and the instance ITC3 both correspond to the cell CA, and the IR drop of the instance ITC1 and the instance ITC3 are 15.1% and 14.8%, respectively. The instance ITC2 corresponds to the cell CB, and the IR drop of the instance ITC2 is 15.0%. The instance ITC4 corresponds to the cell CC, and the IR drop of the instance ITC4 is 14.7%. The sizes of the cells CA, CB, and CC are all greater than or equal to N. In some embodiments, the cells CA, CB, and CC can correspond to different logic gates.

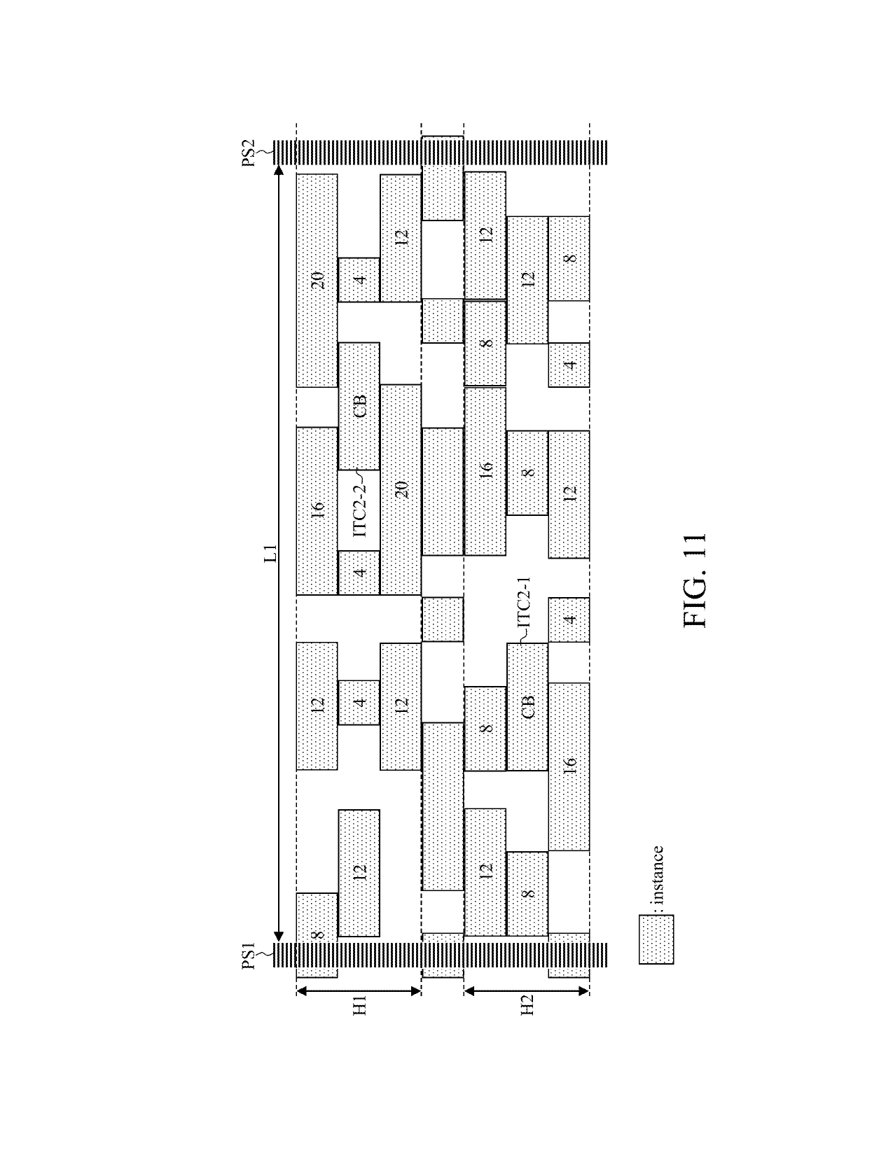

For different instances but the same cell, the computing circuit 210 only selects the one with the greatest IR drop to add to the candidate list. For example, after sorting and counting (as shown in the table in the lower half of FIG. 10), the instance counts of the cells CA, CB, and CC are 150, 11000, and 10, respectively. Assuming that a preset number of instances is selected for each type of cell (e.g., 200 instances; an excessive preset number will cause timing issues in the future that are difficult to solve), the computing circuit 210 divides all the cells CA (because 150 < 200), 200 of the cells CB (because 11000 > 200), and all the cells CC (because 10 < 200). The computing circuit 210 determines the 200 cells CB to be divided based on the weights of the instances. The details will be elaborated below in connection with FIG. 11.

Reference is made to FIG. 11, which is a schematic diagram illustrating the selection of a target cell to be divided according to another embodiment of the present invention. The instance ITC2-1 and the instance ITC2-2 both belong to the instance ITC2 (cell CB), and the values indicated on the other instances represent the sizes of the instances. The computing circuit 210 calculates the weights of the instance ITC2-1 and the instance ITC2-2, respectively. The weight of the instance ITC2-1 is the sum of the instance sizes within the area H2*L1, while the weight of the instance ITC2-2 is the sum of the instance sizes within the area H1*L1. The height H2 includes the row where the instance ITC2-1 is located, as well as the row above and the row below that row. The height H1 includes the row where the instance ITC2-2 is located, as well as the row above and the row below that row. The width L1 is the distance between the power stripe PS1 and the power stripe PS2.

From FIG. 11, it can be seen that because the height of each instance is substantially the same, the area H1*L1 is substantially equal to the area H2*L1. Therefore, the weights of the instance ITC2-1 and the instance ITC2-2 are 128 and 124, respectively. The larger the weight, the higher the possibility that there are instances with large IR drops around that instance. Therefore, when determining the instances of the cell CB, the instance ITC2-1 will be prioritized for dividing.

In summary, by dividing the cell, the present invention can effectively resolve the IR drop issue.

Since a person having ordinary skill in the art can appreciate the implementation detail and the modification thereto of the present method invention through the disclosure of the device invention, repeated and redundant description is thus omitted. Note that the shape, size, and ratio of any element in the disclosed figures are exemplary for understanding, not for limiting the scope of this invention. Furthermore, there is no step sequence limitation for the method inventions as long as the execution of each step is applicable. In some instances, the steps can be performed simultaneously or partially simultaneously.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An electronic device, comprising:
a memory configured to store a circuit placement data and a plurality of codes and/or program instructions; and
a computing circuit coupled to the memory and configured to execute the plurality of codes and/or program instructions to perform following steps:
performing an IR drop analysis based on the circuit placement data;
selecting a target cell;
replacing the target cell with a sub-cell;
setting up a buffer cell;
placing the buffer cell in an area; and
connecting the sub-cell and the buffer cell with a routing.

2. The electronic device of claim 1, wherein the area is adjacent to a cell, and a first IR drop of the cell is less than a second IR drop of the target cell.

3. The electronic device of claim 2, wherein the buffer cell is used to drive the cell.

4. The electronic device of claim 1, wherein the target cell is a first target cell, the sub-cell is a first sub-cell, the buffer cell is a first buffer cell, the IR drop analysis is a first IR drop analysis, and the computing circuit further performs following steps:
solving a timing issue of circuit placement based on the circuit placement data after placing the buffer cell in the area;
performing a second IR drop analysis based on the circuit placement data; and
replacing a second target cell with a second sub-cell and setting up a second buffer cell when an IR drop of the second target cell is greater than or equal to a threshold, and a size of the second target cell is greater than or equal to a size threshold.

5. The electronic device of claim 4, wherein the computing circuit further performs following steps:
placing the second sub-cell and the second buffer cell at a position of the second target cell.

6. The electronic device of claim 4, wherein the second target cell is adjacent to a cell, the second target cell and the cell substantially simultaneously switch logic, and the computing circuit further performs following step:
replacing the cell with a third sub-cell and setting up a third buffer cell.

7. The electronic device of claim 6, wherein the computing circuit further performs following step:
placing the third sub-cell and the third buffer cell at a position of the cell.

8. The electronic device of claim 1, wherein a first size of the target cell is greater than a sum of a second size of the sub-cell and a third size of the buffer cell.

9. An electronic device, comprising:
a memory configured to store a circuit placement data and a plurality of codes and/or program instructions; and
a computing circuit coupled to the memory and configured to execute the plurality of codes and/or program instructions to perform following steps:
solving a timing issue of circuit placement based on the circuit placement data;
performing an IR drop analysis based on the circuit placement data;
replacing a target cell with a sub-cell and setting up a buffer cell when an IR drop of the target cell is greater than or equal to a threshold, and a size of the target cell is greater than or equal to a size threshold.

10. The electronic device of claim 9, wherein the computing circuit further performs following steps:
placing the sub-cell and the buffer cell at a position of the target cell.

11. The electronic device of claim 9, wherein the sub-cell is a first sub-cell, the buffer cell is a first buffer cell, the target cell is adjacent to a cell, the target cell and the cell substantially simultaneously switch logic, and the computing circuit further performs following step:
replacing the cell with a second sub-cell and setting up a second buffer cell.

12. The electronic device of claim 11, wherein the computing circuit further performs following step:
placing the second sub-cell and the second buffer cell at a position of the cell.

13. A circuit design method, comprising:
performing an IR drop analysis based on a circuit placement data;
selecting a target cell;
replacing the target cell with a sub-cell;
setting up a buffer cell;
placing the buffer cell in an area; and
connecting the sub-cell and the buffer cell with a routing.

14. The method of claim 13, wherein the area is adjacent to a cell, and a first IR drop of the cell is less than a second IR drop of the target cell.

15. The method of claim 14, wherein the buffer cell is used to drive the cell.

16. The method of claim 13, wherein the target cell is a first target cell, the sub-cell is a first sub-cell, the buffer cell is a first buffer cell, the IR drop analysis is a first IR drop analysis, and the method further comprises:
solving a timing issue of circuit placement based on the circuit placement data after placing the buffer cell in the area;
performing a second IR drop analysis based on the circuit placement data; and
replacing a second target cell with a second sub-cell and setting up a second buffer cell when an IR drop of the second target cell is greater than or equal to a threshold, and a size of the second target cell is greater than or equal to a size threshold.

17. The method of claim 16, wherein the method further comprises:
placing the second sub-cell and the second buffer cell at a position of the second target cell.

18. The method of claim 16, wherein the second target cell is adjacent to a cell, the second target cell and the cell substantially simultaneously switch logic, and the method further comprises:
replacing the cell with a third sub-cell and setting up a third buffer cell.

19. The method of claim 18, wherein the method further comprises:
placing the third sub-cell and the third buffer cell at a position of the cell.

20. The method of claim 13, wherein a first size of the target cell is greater than a sum of a second size of the sub-cell and a third size of the buffer cell.
